(19) United States
(12) Patent Application Publication
(10) Pub. No.: US 2018/0020713 A1
(43) Pub. Date: Jan. 25, 2018

(54) FRUIT FLESH EXTRACTING MACHINE

(71) Applicant: THE STATE OF ISRAEL, MINISTRY OF AGRICULTURE & RURAL DEVELOPMENT, Beit Dagan (IL)

(72) Inventors: Ze'ev SCHMILOVITCH, Yehud Monson (IL); Victor ALCHANATIS, Mazkeret Batya (IL); Timea IGNAT, DN Emek Sorek (IL); Aharon HOFFMAN, Ramat Gan (IL); Haim EGOZI, Hod Hasharon (IL); Benyamin RONEN, Kefar Sabe (IL); Viacheslay OSTROVSKY, Rishon LeZion (IL); Victor RODOV, Petah Tikva (IL); Yakov VINOKUR, Rishon-LeZion (IL)

(21) Appl. No.: 15/546,011

(22) PCT Filed: Jan. 25, 2016
(86) PCT No.: PCT/IL2016/050076

§ 371 Date: Jul. 25, 2017

Related U.S. Application Data
(60) Provisional application No. 62/107,418, filed on Jan. 25, 2015.

(51) Int. Cl. A23N 4/12; A23N 3/04

(52) U.S. Cl. CPC A23N 4/12; A23N 3/04

(57) ABSTRACT

A fruit flesh extracting machine for extracting a flesh of a fruit is provided. The machine includes a conveyor configured for, carrying and displacing the fruit; an edge removing station configured for slicing at least one edge of the fruit; and a flesh extracting station having a first scoop slidabley and transversely mounted with respect to the conveyor and being configured for scooping out the flesh of the fruit. The conveyor is configured to displace the fruit between the edge removing station and the flesh extracting station.

### FIELD OF INVENTION

The presently disclosed subject matter relates to fruit flesh extracting machine, in general, and in particular to a fruit flesh extracting machine for extracting an inner flesh of a fruit.

### BACKGROUND

Marketing of ready to eat fresh produce has an increasing share of supermarket shelf space around the world. Furthermore, this is also comes along with the requirements of consumer to purchase only small portion of large and heavy fruit such as watermelon. Most products are prepared manually or with partially mechanized. Mechanization of fruit peeling and cutting is a known procedure mainly in canned fruits and vegetables production. As an exception, an automatized technology and mechanization for production of fresh produce was developed by the Institute of Agricultural Engineering for extracting pomegranate arils and (Schmilovitch, Z., et al. Israel Patent IL154398 and Schmilovitch, Z., et al. USA patent No: U.S. Pat. No. 7,968,136B2)

### SUMMARY OF INVENTION

There is provided in accordance with an aspect of the presently disclosed subject matter a fruit flesh extracting machine for preparing fresh cut ready to eat produce. The machine includes a conveyor configured for, carrying and displacing the fruit; an edge extracting station configured for slicing at least one edge of the fruit; and a flesh extracting station having a first scoop slidabley and transversely mounted with respect to the conveyor and being configured for scooping out the flesh of the fruit. The conveyor is configured to displace the fruit between the edge extracting station and the flesh extracting station.

The conveyor can include a frame extending between a feeding area configured to receive the fruits and a dispensing area for dispensing a peel of the fruit.

The conveyor can include a plurality of moving member configured to be displaced along the path of the conveyor, and configured such that a pair of adjacent moving members are configured to hold a fruit therebetween and to displace the fruit along the path of the conveyor.

Each moving member can include a first conical drum and a second opposing conical drum, disposed such that a narrow portion of the first conical drums is adjunct a narrow portion of the second opposing conical drums. Each of the conical members is configured with a slope corresponding with a shape of the fruits the conveyor is intended to hold.

The fruit flesh extracting machine can further includes an auxiliary drive configured to rotate the moving member about its own axis urging thereby the fruit disposed thereon to be orientated such that it is disposed in perpendicular to the conveyor.

The edge removing station can include at least one slicer slidably mounted and configured to selectively slide towards the conveyor and to thereby slice the edges of the fruit.

The at least one slicer can include a triangular blade configured such that a sharp edge thereof projects in a direction towards the conveyor and configured to form an opening in the fruit at one edge thereof, wherein the opening is perpendicular to the axis of the conveyor. The edge removing station can further include a catch member configured to hold the fruit in place while the edge thereof is being sliced.

The fruit flesh extracting machine can further include a coring station having first scoop slidabley and transversely mounted with respect to the conveyor and being configured for scooping out the core of the fruit.

The first scoop can be mounted between the edge removing station and the flesh extracting station. The at least one of the first scoop and second scoop can be coupled to a piston configured to selectively slide the at least one of the first scoop and second scoop back and forth along a perpendicular axis with respect to the conveyor. The at least one of the first scoop and second scoop can be further configured to rotate about its own axis while engaging the flesh of the fruit.

The at least one of the first scoop and second scoop can include a semi cylindrical portion configured to engage an inner flesh of the fruit.

The least one of the flesh extracting station and coring station can include a catch member configured to selectively hold the fruit. The catch member can be configured to slide toward the conveyor and to firmly push a fruit disposed thereon against the conveyor.

The fruit flesh extracting machine can further include a slicing station configured to slice an inner flesh of the fruit extracted from the fruit. The slicing station can include a rotating knife mounted adjacent the flesh extracting station and being configured to rotate about an axis parallel to the axis of the first scoop. The first scoop of the flesh extracting station can be configured to extract a cylindrical shape portion of the fruit and the rotating knife is configured to slice the cylindrical shape portion to a plurality of disk portions.

### BRIEF DESCRIPTION OF THE DRAWINGS

In order to understand the disclosure and to see how it may be carried out in practice, embodiments will now be described, by way of non-limiting examples only, with reference to the accompanying drawings, in which:

FIG. 1A is a perspective view of a fruit flesh extracting machine in accordance with an example of the presently disclosed subject matter;

FIG. 1B is a side view of the fruit flesh extracting machine of FIG. 1A;

FIG. 1C is a side perspective view of the fruit flesh extracting machine of FIG. 1A with a portion of the frame thereof removed;

FIG. 2A is a schematic illustration of a top view of the conveyor of the fruit flesh extracting machine of FIG. 1A;

FIG. 2A is a schematic illustration of the slicing station of the fruit flesh extracting machine of FIG. 1A;

FIG. 3A is a top view of the fruit flesh extracting machine of FIG. 1A;

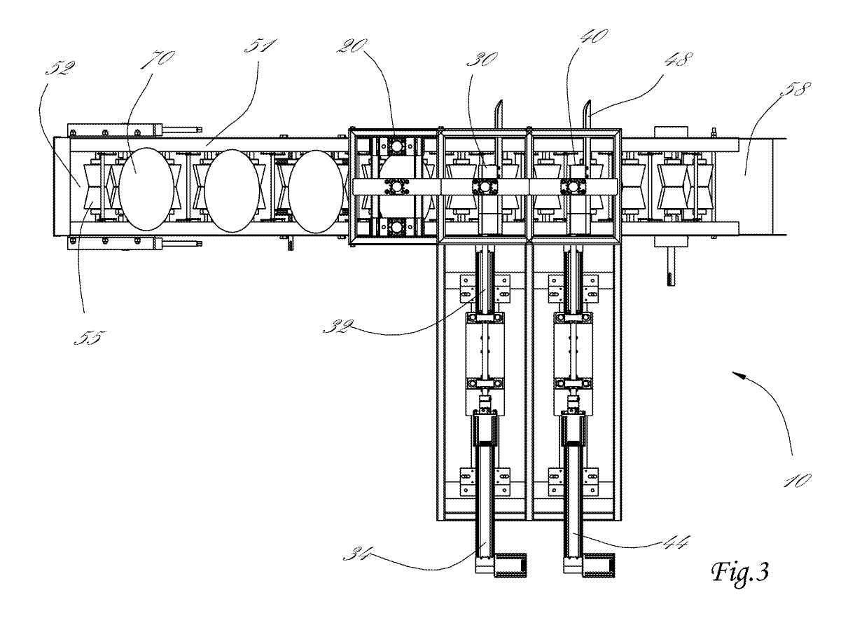

FIG. 4A is a side perspective view of a slicer of the fruit flesh extracting machine of FIG. 1A in accordance with an example of the presently disclosed subject matter;

FIG. 4B is a side perspective view of a catch member of the fruit flesh extracting machine of FIG. 1A in accordance with an example of the presently disclosed subject matter;

FIG. 4C is a side perspective view of a scoop of the fruit flesh extracting machine of FIG. 1A in accordance with an example of the presently disclosed subject matter, and

FIG. 5 is a side perspective view of a slicing station in accordance with an example of the presently disclosed subject matter.

### DETAILED DESCRIPTION OF EMBODIMENTS

The presently disclosed subject matter provides a fruit flesh extracting machine for fruit flesh extracting and extracting a flesh of a fruit, such as a melon, watermelon, pineapple, pumpkin etc. The fruit flesh extracting machine includes a edge removing station for slicing the edges of the fruit, a fruit flesh extracting station in which the core of the fruit is removed, and a flesh extracting station in which the flesh of the fruit is removed. This way, the fruit flesh is peeled and cut into a cylindrical shape, which can then be packed or sliced into ring shape fruit portions.

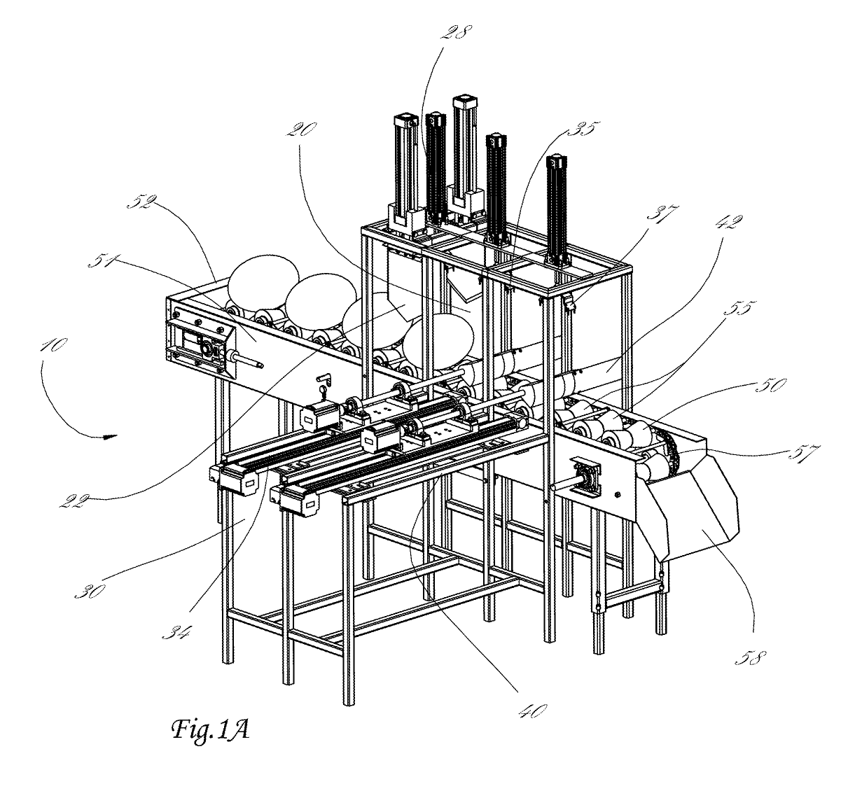

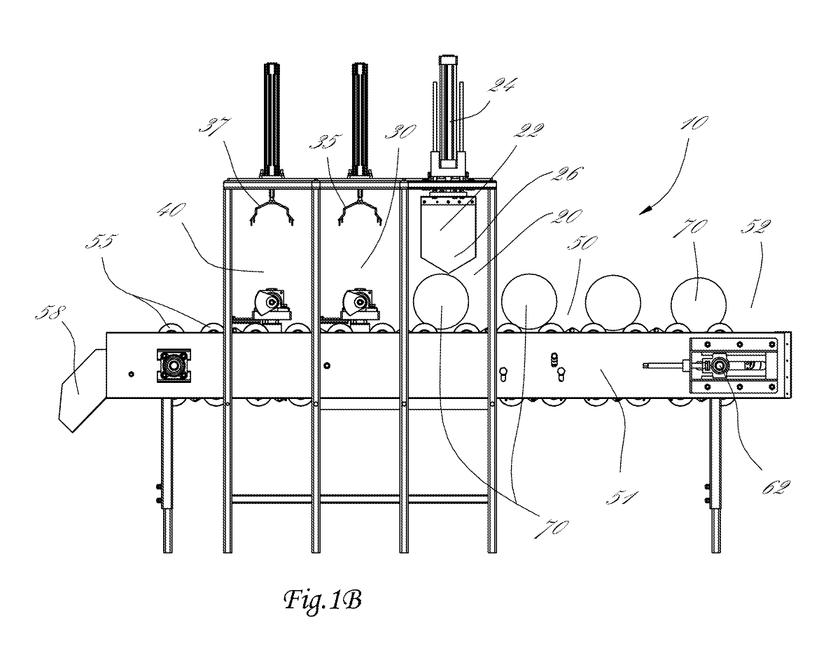

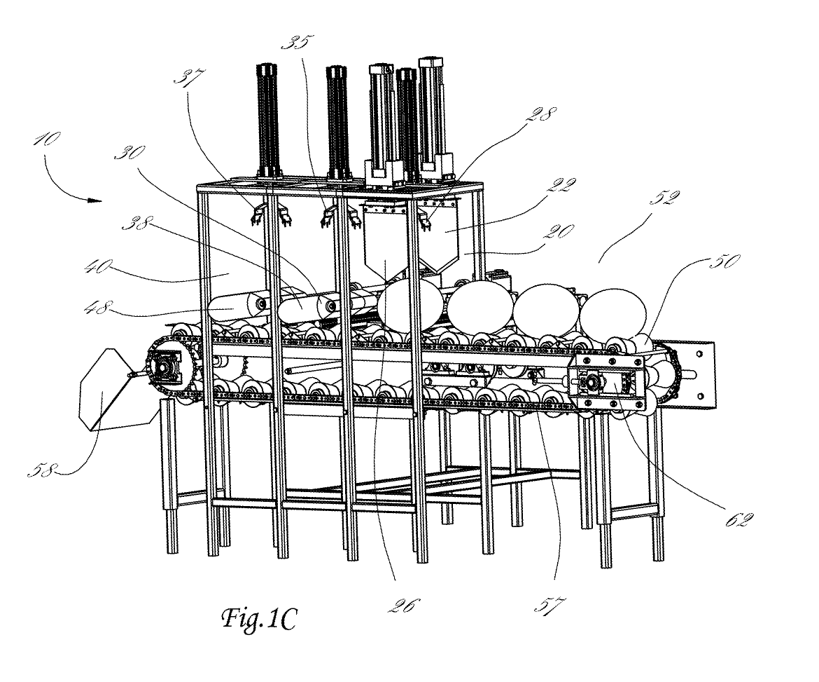

FIGS. 1A to 1C illustrates a fruit flesh extracting machine 10, according to an example, having an edge removing station 20 for removing the edges of the fruit, and a flesh extracting station 40 in which the flesh of the fruit is removed. The fruit flesh extracting machine 10 can optionally include a coring station 30 in which the core of the fruit is removed, for example for removing the seeds in the core of a melon. The fruit flesh extracting machine 10 further includes a conveyor 50 configured to transfer the fruit between the various stations.

The conveyor 50 includes a frame 51 which can extend between a feeding area 52 in which the fruits are placed on the conveyor 50 and a dispensing area 58, in which the peel of the fruit is transferred to a collecting area, such as a garbage bin, etc.

The feeding area 52 can be configured to receive the fruits from a feeding device such as a conveyor belt, or other robotic feeding system configured place the fruits on the feeding area 52 of the conveyor 50.

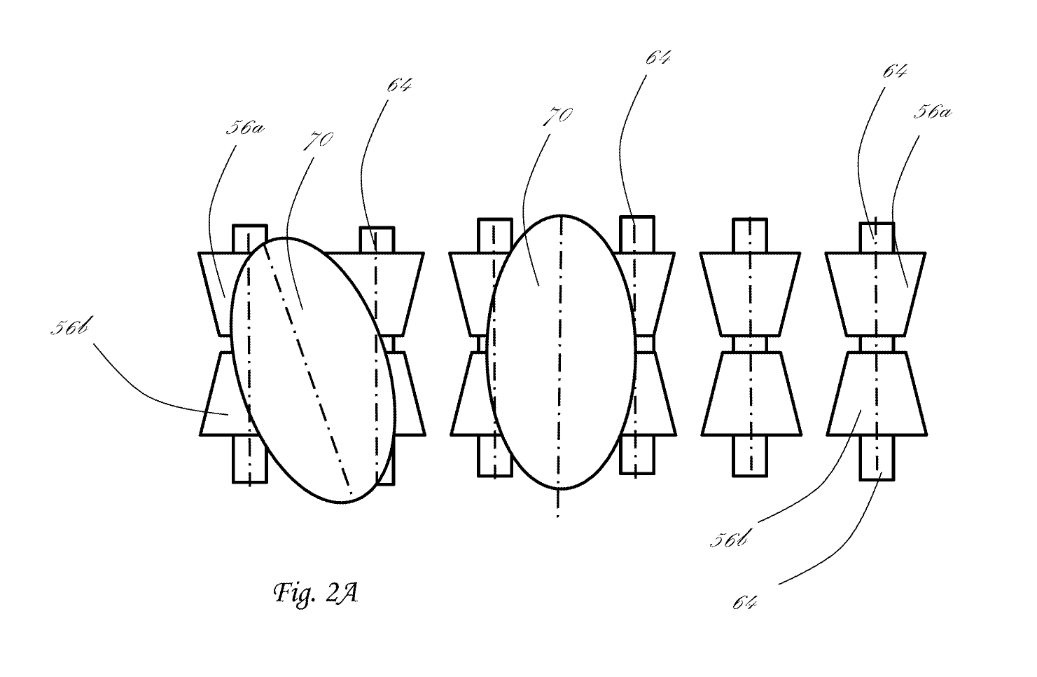

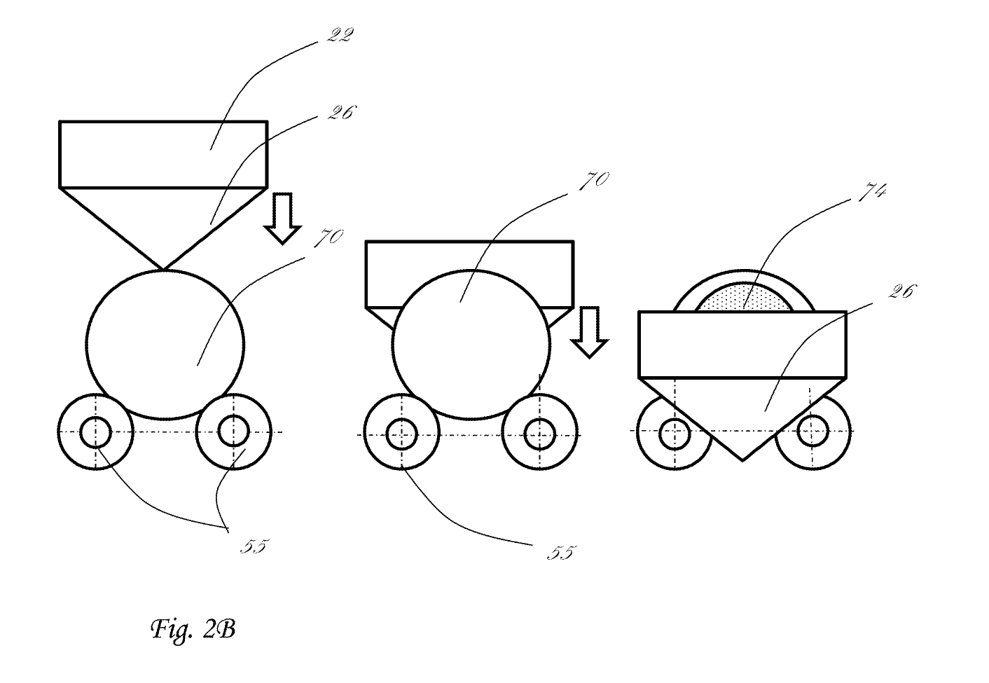

The conveyor 50 includes a plurality of moving member 55, each having two opposing conical drums 56a and 56b, as shown in FIG. 2A, such that the narrow portion of a first conical drums 56a is adjunct the narrow portion of a second opposing conical drums 56b. The moving members 55 are configured to be displaced along the path of the conveyor from feeding area 52 towards the dispensing area 58 and to rotate to the bottom of the frame 51 and to further be displaced back towards the feeding area 52 where they rotate back to the top of the frame 51.

According to the illustrated example, the moving member 55 are coupled to a roller chain 57 extending alongside the frame 51 and being coupled to a motor 62. Each of the moving member 55 can be coupled to the roller chain 57 via a shaft 64 extending from the wide portion of the conical drums 56. According to an example, the conveyor 50 includes two roller chain 57, each extending alongside one edge of the frame, such that the first conical drums 56a is coupled to one roller chain 57 while the second opposing conical drums 56b is coupled to the second roller chain 57, also known as a grommet arrangement.

The conveyor 50 is configured such that each pair of moving member 55 allows holding one fruit. That is to say, the distance between two adjacent moving members is configured to allow disposing a fruit there between such that the fruit is snugly fit. In addition, the slope of the conical member is configured in accordance with shape of the fruits the conveyor is intended to hold. That is to say, as shown in FIG. 2A, the area between two adjacent moving member 55 is configured such that when the fruit 70 is placed thereon the fruit tends to be displaced to a perpendicular orientation with respect to the conveyor 50, i.e. the edges 75 of the fruit 70 are each disposed adjacent one of the roller chain 57. Due to the slopes of the conical drums 56a and 56b if the fruit is placed in diagonal with respect to the conveyor 50, the fruit 70 tends to slide into the gap between each pair of moving member 55 such that it is perpendicularly disposed with respect to the conveyor 50.

According to an example, orientation of the fruits 70 on the conveyor 50 is carried out by an auxiliary drive (not shown) configured to rotate the conical drums 56a and 56b about the axis thereof. In other words, while the conveyor 50 is configured to displace the moving member 55 along the frame 51 the auxiliary drive is configured to rotate the drums 56a and 56b of each the moving member 55, for example by rotating the shaft 65. The auxiliary drive can include an engaging wheel mounted under the feeding area 52 of the conveyor 50, and can be configured to rotate while engaging the drums 56a and 56b of the moving member 55, causing thereby the rotation of the drums 56a and 56b.

The rotation of the drums 56a and 56b at the feeding area 52 thus causes the fruit 70 to be orientated such that it is disposed substantially in perpendicular to the conveyor 50. It is appreciated that the auxiliary drive can be configured to operate together with the conveyor 50 or to be actuated when a fruit is placed on the feeding area 52 or when a fruit 70 on the feeding area 52 is disorientated.

The fruit edge removing station 20 of the fruit flesh extracting machine 10 includes a slicer 22 slidably mounted on the fruit flesh extracting machine 10 and configured to selectively slide towards the conveyor 50 and to slice the edges of the fruit 70. According to the illustrated example, the slicer 22 slidably mounted on top of the conveyor 50, such that when it slides towards the fruit 70 the fruit is pressed between the slicer 22 and the moving member 55 facilitating thereby the slicing of the edge of the fruit. The fruit edge removing station 20, according to an example includes a pair of slicers 22 configured to simultaneously slide towards the conveyor 50 and to slice both edges of the fruit 70.

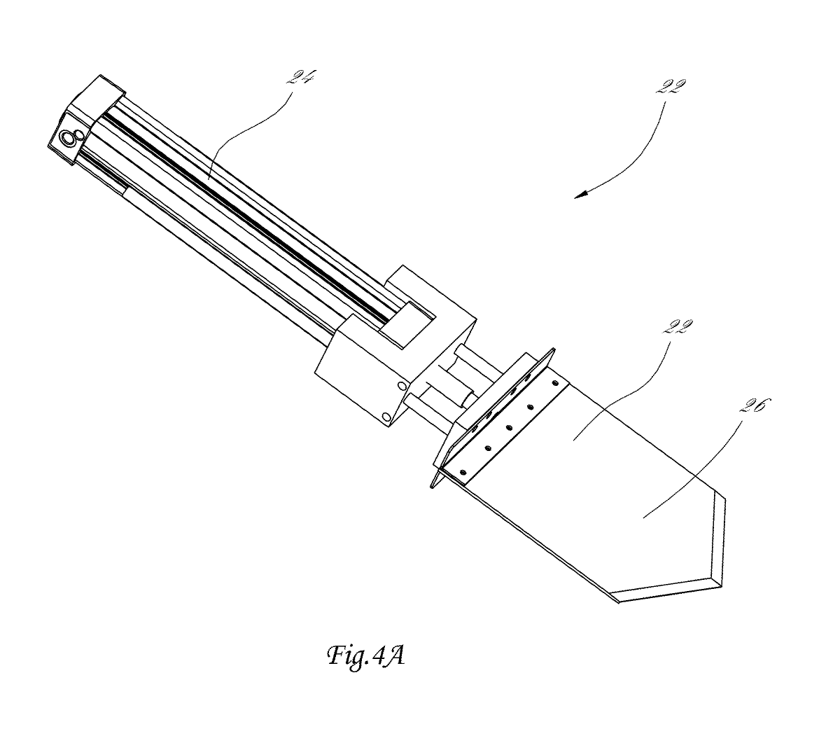

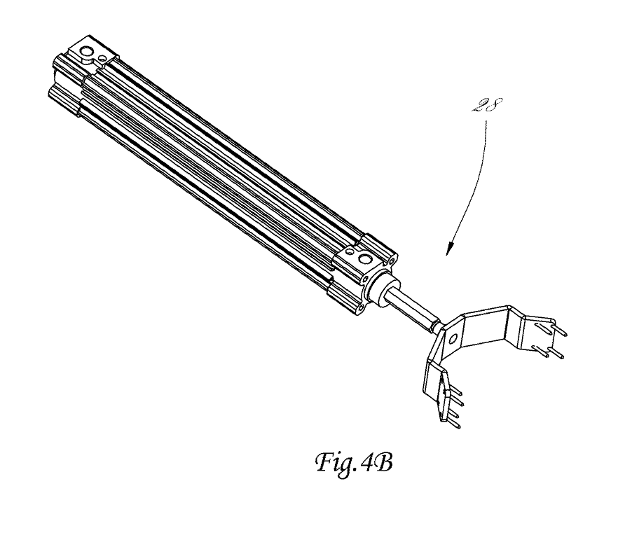

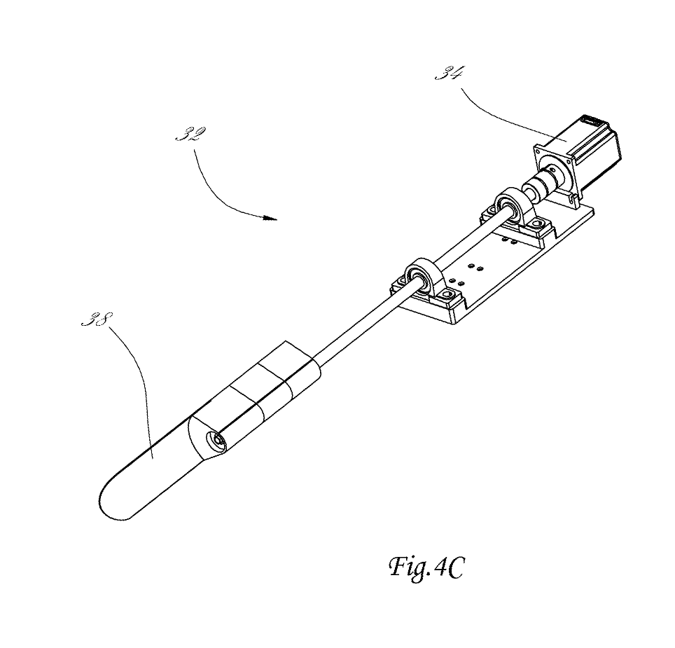

As shown in FIG. 4A, each of the slicers 22 can include a piston 24 configured to slide the slicer 22 towards and away from the fruit 70. The slicers 22 can include a triangular blade 26 such that the sharp edge thereof projects in a direction towards the edge of the fruit. The width of the triangular blade 26 generally extends on an axis parallel to the axis of the conveyor 50 such that the edge of the fruit 70 is sliced in a direction substantially parallel to the axis of the conveyor 50. This way, as shown in FIG. 2B, each of the slicers 22 form an opening 74 in the fruit at one edge thereof, wherein the opening 74 is perpendicular to the axis of the conveyor 50.

In order to preclude displacement of the fruit 70 during the edge slicing process, the fruit edge removing station 20 further includes a catch member 28 (shown in FIG. 4B) configured to slide toward the fruit 70 and to firmly push the fruit 70 against the moving member 55 on which it is disposed. The catch member 28 can be configured to slide together or imminently prior to the sliding of the slicers 22 towards the fruit 70. This way, the slicers 22 can accurately slice the edge of the fruit 70 while the latter is stable in the position thereof.

The slicer 22 and the catch member 28 are thus configured to selectively slide towards the fruit, when a fruit 70 is disposed at a location on the conveyor 50 corresponding to the edge removing station 20. The slicers 22 can be provided with a detector for detecting a fruit, and be configured to slide towards the fruit, or can be configured to slide down at a predetermined time synchronized with the movement of the conveyor 50.

As indicated hereinabove, the fruit flesh extracting machine 10 includes a flesh extracting station 40 having a first scoop 42 for removing the inner flesh of the fruit. In the illustrated example, the fruit flesh extracting machine 10 further includes a coring station 30 having a second scoop 32 for removing the core of the fruit. The coring stage can be carried out before or after the inner flesh is extracted. According to the illustrated example however the coring station 30 is disposed along the conveyor before the flesh extracting station 40 such that the coring stage is carried out before the fruit flesh is extracted. Thus in the following description the coring station 30 is discussed before the flesh extracting station 40.

The second scoop 32 is slidably mounted with respect to the conveyor 50 in perpendicular to the axis of the conveyor 50. The second scoop 32 is configured to slide and engage the inner core of the fruit 70 through the opening 74 formed at the edge of the fruit in the edge removing station 20. As shown in FIG. 4C, the second scoop 32 is coupled to a piston 34 configured to selectively slide the scoop 32 back and forth. The scoop 32 is further configured to rotate about its own axis, for example by means of a step or servo motor integrated inside the piston 34.

The second scoop 32, according to the present example includes a semi cylindrical portion 38, configured to engage the inner core of the fruit 70, for example where the seeds of the fruit are located.

The piston 34 is configured to slide the scoop 32 towards the opening 74 of the fruit semi cylindrical portion 38 when a fruit is disposed on a location on the conveyor 50 corresponding to the location of the coring station 30. Once the piston 34 is extended to its fully extended position, the scoop 32 is rotated separating thereby the core of the fruit 70 from the inner flesh thereof. The piston 34 can then be configured to be retracted such that the scoop 32 with the already separated core of the fruit is extracted out of the fruit 70.

It is appreciated that the piston 34 can be configured to extend the scoop 32 forward towards the fruit 70, such that the end of the scoop 32 engages the proximal edge of the fruit 70 and to further extend the scoop 32 until it reaches the distal edge of the fruit 70. This way, the entire core of the fruit can be cut and removed therefrom.

Once the piston 34 is retracted and the scoop 32 is disposed away from the fruit 70, the scoop 32 can be rotated allowing thereby the core disposed inside the scoop 32 to gravitate, for example, to collecting bin disposed underneath the scoop 32.

As indicated hereinabove with regards to the fruit edge removing station 20, the scoop 32 can operate automatically in response to a fruit disposed adjacent the coring station 30, or at a predetermined cycle corresponding to the moving rate of the conveyor 50.

According to an example, in order to preclude displacement of the fruit 70 during the core removing process, the coring station 30 can further include a catch member 35, similar to the catch member 28 of the edge removing station 20 configured to slide toward the fruit 70 and to firmly push the fruit 70 against the moving member 55 on which it is disposed. The catch member 35 can be configured to slide together or imminently prior to the sliding of the scoop 32 towards the fruit 70. This way, the scoop 32 can accurately remove the core of the fruit 70 while the latter is stable in the position thereof.

The flesh extracting station 40 includes a first scoop 42 slidably mounted with respect to the conveyor 50 in perpendicular to the axis of the conveyor 50, and adjacent the second scoop 32. The first scoop 42 is configured to slide and engage the inner flesh of the fruit 70 through the opening 74, formed at the edge of the fruit 70 in the edge removing station 20. Similar to the second scoop 32, the first scoop 42 is coupled to a piston 44 configured to selectively slide the scoop 42 back and forth. The scoop 42 is further configured to rotate about its own axis, for example by means of a motor integrated inside the piston 44.

The second scoop 42, according to the present example includes a semi cylindrical portion 48, configured to engage the flesh of the fruit 70, for example, at periphery of the fruit 70, in close proximity to the inner surface of the peel of the fruit.

It is appreciated that the radius of the semi cylindrical portion 48 of the first scoop 42 is larger than the radius of the semi cylindrical portion 38 of the second scoop 32. Thus, while the second scoop 32 removes the core of the fruit 70, the first scoop 42 is configured to cut the flesh of the fruit 70.

The piston 44 is configured to slide the scoop 42 towards the opening 74 of the fruit semi cylindrical portion 48 when a fruit is disposed on a location on the conveyor 50 corresponding to the location of the flesh extracting station 40. Once the piston 44 is extended to its fully extended position, the scoop 42 is rotated separating thereby the flesh of the fruit 70 from the inner surface of the peel thereof. The piston 44 can then be configured to be retracted such that the scoop 42 with the already separated flesh of the fruit is extracted out of the fruit 70. At this position, since the core of the fruit 70 is already removed at the coring station 30, the extracted flesh is in a shape of cylinder.

The size of the cylindrically shape fruit portion can be configured by adapting the radius of the semi cylindrical portion 38 of the second scoop 32 and the radius of the semi cylindrical portion 48 of the second scoop 42. That is to say, the second scoop 32 includes a radius configured for coring a center portion of the fruit so as to allow seeds removal, while the first scoop 42 includes a radius in accordance with the fruit peel dimensions.

It is appreciated that the piston 44 can be configured to extend the scoop 42 forward towards the fruit 70, such that the end of the scoop 42 engages the proximal edge of the fruit 70 and to further extend the scoop 42 until it reaches the distal edge of the fruit 70. This way, the entire flesh of the fruit can be cut and separated from the peel of the fruit.

Once the piston 44 is retracted and the scoop 42 is disposed away from the fruit 70, the scoop 42 can be rotated allowing thereby the cylindrical shape flesh disposed inside the scoop 42 to gravitate, for example, to collecting bin disposed underneath the scoop 42.

According to an example, in order to preclude displacement of the fruit 70 during the flesh extracting process, the flesh extracting station 40 can further include a catch member 37, similar to the catch member 35 of the coring station 30.

As indicated hereinabove with regards to the edge removing station 20, the scoop 42 can operate automatically in response to a fruit disposed adjacent the flesh extracting station 40, or at a predetermined cycle corresponding to the moving rate of the conveyor 50.

The peel of the fruit 70 which is remained on the conveyor 50 can be displaced further towards the dispensing area 58 where the moving members 55 are rotated to the bottom of the frame 51, such that the empty peels are dispended to a garbage bin (not shown).

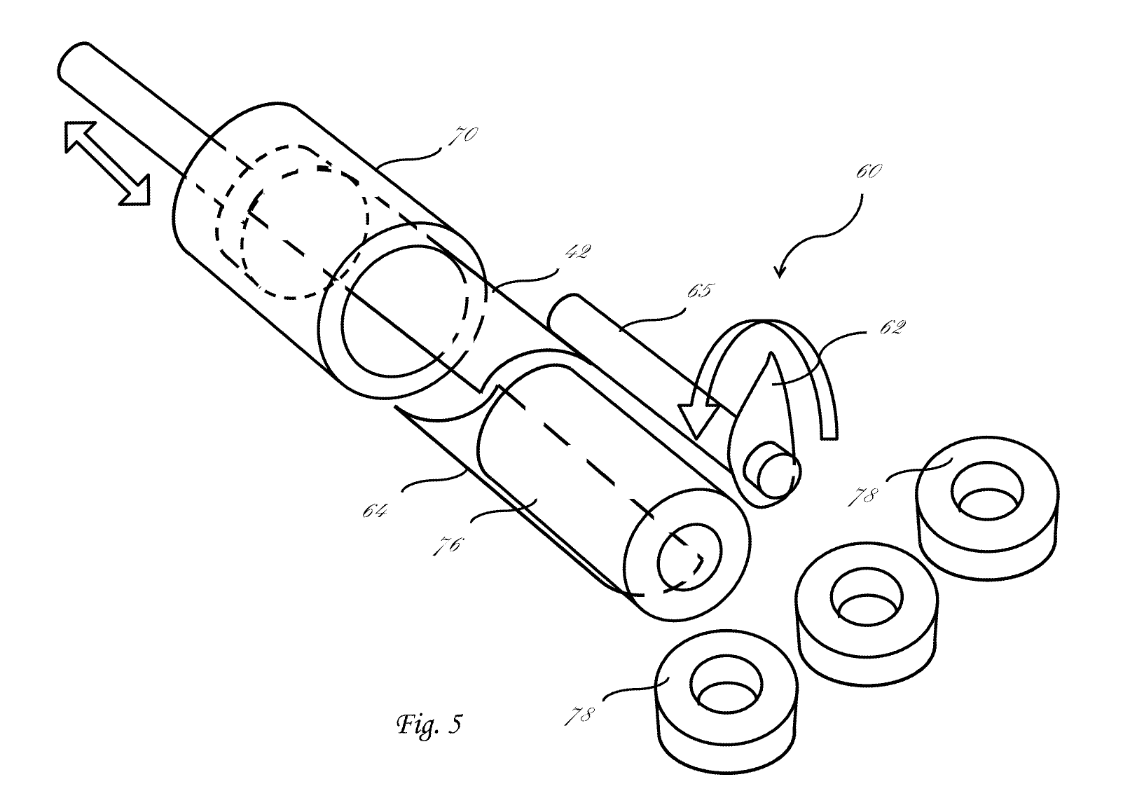

As shown in FIG. 5, the cylindrical shape portion 76 of the fruit can be sliced to ring shapes and can be canned or packed as desired. For example, a slicing station 60 can be added to the fruit flesh extracting machine 10, and can be configured to cooperate with the flesh extracting station 40. The slicing station 60 can include a holding tray 62 which can be a semi cylindrical tray coaxially disposed with respect to the displacement axis of the second scoop 42. For example, the holding tray 62 such that displacement of the first scoop 42 towards the fruit 70 when the latter is in the flesh extracting station 40, allows extracting the flesh thereof. As explained hereinabove, rotation of the scoop 42 removes the cylindrical shape portion 76 of the fruit 70, such that further displacement of the first scoop 42 in the same direction displaces the cylindrical shape portion 76 towards the holding tray 62.

The slicing station 60 can further includes a rotating knife 62 perpendicularly disposed with respect to the cylindrical shape portion 76 and being configured to rotate on a shaft 65. The shaft 65 is disposed with parallel to the cylindrical shape portion 76. This way, the rotating knife 62 can slice the cylindrical shape portion 76 of the fruit 70 to disk shape portions 78. It is appreciated that the length of the knife, and the distance thereof from the holding tray 62 can be configured in accordance with the size of the fruit 70.

It should be noted that all the stations can be operated automatically and parallel in sequence so several fruits are treated each one in a different stage of the fruit flesh extracting sequence. So while one fruit is placed and oriented at the fruit feeding area 52, other one is being cut out of edges at the edge extracting station 20 and other one is being cored and the flesh thereof removed such that the fruit is left with an empty peel.

Those skilled in the art to which the presently disclosed subject matter pertains will readily appreciate that numerous changes, variations, and modifications can be made without departing from the scope of the invention, mutatis mutandis.

1. A fruit flesh extracting machine for extracting a flesh of a fruit, the machine comprising:
a conveyor configured for, carrying and displacing the fruit;
an edge removing station configured for slicing at least one edge of the fruit; and,
a flesh extracting station having a first scoop slidabley and transversely mounted with respect to the conveyor and being configured for scooping out the flesh of the fruit;
wherein said conveyor is configured to displace the fruit between said edge removing station and said flesh extracting station.

2. The fruit flesh removing machine of claim 1 wherein said conveyor includes a frame extending between a feeding area configured to receive the fruits and a dispensing area for dispensing a peel of the fruit.

3. The fruit flesh extracting machine of claim 2 wherein said conveyor includes a plurality of moving member configured to be displaced along the path of the conveyor, and configured such that a pair of adjacent moving members are configured to hold a fruit therebetween and to displace the fruit along the path of the conveyor.

4. The fruit flesh extracting machine of claim 3 wherein each moving member includes a first conical drum and a second opposing conical drum, said first and second conical drum are disposed such that a narrow portion of said first conical drums is adjunct a narrow portion of said second opposing conical drums.

5. The fruit flesh extracting machine of claim 3 wherein each of said conical drum is configured with a slope corresponding with a shape of the fruits the conveyor is intended to hold.

6. The fruit flesh extracting machine of claim 3 further comprising an auxiliary drive configured to rotate said moving member about its own axis urging thereby the fruit disposed thereon to be orientated such that it is disposed in perpendicular to the conveyor.

7. The fruit flesh extracting machine of claim 1 wherein said edge removing station includes at least one slicer slidably mounted and configured to selectively slide towards the conveyor and to thereby slice the edges of the fruit.

8. The fruit flesh extracting machine of claim 7 wherein said at least one slicer includes a triangular blade configured such that a sharp edge thereof projects in a direction towards the conveyor and configured to form an opening in the fruit at one edge thereof, wherein said opening is perpendicular to the axis of the conveyor.

9. The fruit flesh extracting machine of claim 7 wherein said edge removing station further includes a catch member configured to hold the fruit in place while the edge thereof is being sliced.

10. The fruit flesh extracting machine of claim 1 further comprising a coring station having second scoop slidabley and transversely mounted with respect to the conveyor and being configured for scooping out the core of the fruit.

11. The fruit flesh extracting machine of claim 10 wherein said second scoop is mounted between said edge removing station and said flesh removing station.

12. The fruit flesh extracting machine of claim 11 wherein at least one of said first scoop and second scoop is coupled to a piston configured to selectively slide said at least one of said first scoop and second scoop back and forth along a perpendicular axis with respect to said conveyor.

13. The fruit flesh extracting machine of claim 11 wherein at least one of said first scoop and second scoop is further configured to rotate about its own axis while engaging the flesh of the fruit.

14. The fruit flesh extracting machine of claim 11 wherein at least one of said first scoop and second scoop includes a semi cylindrical portion configured to engage an inner flesh of the fruit.

15. The fruit flesh extracting machine of claim 11 wherein at least one of said flesh extracting station and coring station includes a catch member configured to selectively hold the fruit.

16. The fruit flesh extracting machine of claim 11 wherein said catch member is configured to slide toward the conveyor and to firmly push a fruit disposed thereon against the conveyor.

17. The fruit flesh extracting machine of claim 1 further comprising a slicing station configured to slice an inner flesh of the fruit extracted from said fruit.

18. The fruit flesh extracting machine of claim 1 wherein said slicing station includes a rotating knife mounted adjacent said flesh extracting station and being configured to rotate about an axis parallel to the axis of said first scoop.

19. The fruit flesh extracting machine of claim 19 wherein said first scoop of said flesh extracting station is configured to extract a cylindrical shape portion of the fruit and said rotating knife is configured to slice said cylindrical shape portion to a plurality of disk portions.
